(19) United States
(12) Patent Application Publication
(10) Pub. No.: US 2014/0043219 A1
(43) Pub. Date: Feb. 13, 2014

(54) LIGHT EMITTING DEVICE, ELECTRONIC APPARATUS, AND METHOD OF DRIVING LIGHT EMITTING DEVICE

(71) Applicant: SEIKO EPSON CORPORATION, Tokyo (JP)

(72) Inventor: Hitoshi OTA, Shiojiri-shi (JP)

(73) Assignee: SEIKO EPSON CORPORATION, Tokyo (JP)

(21) Appl. No.: 14/060,226

(22) Filed: Oct. 22, 2013

Related U.S. Application Data
(62) Division of application No. 13/038,669, filed on Mar. 2, 2011.

(30) Foreign Application Priority Data
Mar. 11, 2010 (JP) 2010-054098

(51) Int. Cl. G09G 3/32

(52) U.S. Cl. CPC G09G 3/3266
USPC 345/80

(57) ABSTRACT

A light emitting device includes a pixel circuit and a data line provided between a first substrate and a second substrate opposed to each other. The pixel circuit includes a first circuit and a second circuit, the first circuit includes a first light emitting element and a first driving transistor connected in series to each other, and a first switching element provided between a gate of the first transistor and the data line, and outgoing light of the first light emitting element is output from the first substrate side. The second circuit includes a second light emitting element and a second driving transistor connected in series to each other, and a first switching element provided between a gate of the second driving transistor and the data line, and outgoing light of the second light emitting element is output from the second substrate side.

### REFERENCE TO COPENDING APPLICATIONS

This application is a Divisional of application Ser. No. 13/038,669 filed Mar. 2, 2011, which claims priority from Japanese Patent Application JP 2010-054098 filed Mar. 11, 2010. The disclosure of the prior applications is hereby incorporated by reference herein in their entirety.

### BACKGROUND

1. Technical Field

The present invention relates to a light emitting device, an electronic apparatus, and a method of driving the light emitting device.

2. Related Art

Recently, various light emitting devices employing a light emitting element such as an organic light emitting diode (hereinafter, referred to as “OLED”) element called an organic EL (Electro Luminescent) element, a light emitting polymer element, or the like have been proposed. For example, in JP-A-2006-128077, a double-sided light emitting-type light emitting device capable of simultaneously displaying different images on one face and the other face of a panel is disclosed.

FIG. 16 is a diagram illustrating a configuration of a pixel circuit in the light emitting device disclosed in JP-A-2006-128077. As shown in FIG. 16, the pixel circuit is provided with a first driving transistor 122 and a first light emitting element 12a connected in series to each other, a first storage capacitor CT interposed between a gate and a source of the first driving transistor 122, a first selection transistor 120 provided between the gate of the first driving transistor 122 and a first data line 102T, a second driving transistor 123 and a second light emitting element 12b connected in series to each other, a second storage capacitor CB interposed between a gate and a source of the second driving transistor 123, and a second selection transistor 121 provided between the gate of the second driving transistor 123 and a second data line 102B. Outgoing light of the first light emitting element 12a is output from one face of a panel, and outgoing light of the second light emitting element 12b is output from the other face of the panel, thereby realizing double-sided light emission.

The gate of the first selection transistor 120 is connected to a first scanning line 101T. When the first scanning line 101T is selected, the first selection transistor 120 is turned on, and the first data line 102T and the gate of the first driving transistor 122 are electrically connected. In this case, data potential Da corresponding to a designation gradation of the first light emitting element 12a is output to the first data line 102T, and thus the data potential Da is supplied to the gate of the first driving transistor 122. Accordingly, a driving current corresponding to the data potential Da flows in the first light emitting element 12a, and the first light emitting element 12a emits light in a brightness corresponding to the driving current.

The gate of the second selection transistor 121 is connected to a second scanning line 101B. When the second scanning line 101E is selected, the second selection transistor 121 is turned on, and the second data line 102E and the gate of the second driving transistor 123 are electrically connected. In this case, data potential Db corresponding to a designation gradation of the second light emitting element 12b is output to the second data line 102B, and thus the data potential Db is supplied to the gate of the second driving transistor 123. Accordingly, the driving current corresponding to the data potential Db flows in the second light emitting element 12b, and the second light emitting element 12b emits light in a brightness corresponding to the driving current.

In JP-A-2006-128077, two data lines 102T and 102B are necessary for each pixel, and it is difficult to reduce the area per one pixel. Accordingly, there is a problem that it is difficult to achieve high precision of an image.

### SUMMARY

An advantage of some aspects of the invention is to provide a double-sided light emitting-type light emitting device capable of achieving high precision.

According to an aspect of the invention, there is provided a light emitting device including: a pixel circuit that is provided on a substrate; and a data line, wherein the pixel circuit includes a first circuit and a second circuit provided corresponding to a first supply line (for example, high potential supply line 16 in FIG. 2), wherein the first circuit includes a first light emitting element, a first driving transistor connected between the first light emitting element and the first supply line, and a first switching element provided between a gate of the first driving transistor and the data line, and outgoing light of the first light emitting element is output from one side (for example, first substrate 31 side) of the substrate, and wherein the second circuit includes a second light emitting element, a second driving transistor connected between the second light emitting element and the first supply line, and a second switching element provided between a gate of the second driving transistor and the data line, and outgoing light of the second light emitting element is output from the other side (for example, second substrate 32 side) of the substrate.

In the aspect of the invention, the first circuit for generating an image displayed on one side of the substrate and the second circuit for generating an image displayed on the other side of the substrate share one data line, and thus it is possible to reduce an area per one pixel as compared with the aspect (two data lines are provided for each pixel) of separately providing the data line corresponding to the first circuit and the data line corresponding to the second circuit. Accordingly, there is an advantage of achieving high precision of the image.

The light emitting device according to the aspect of the invention further includes a driving circuit that drives the pixel circuit, in a first period, the driving circuit sets the first switching element to be turned on and the second switching element to be turned off, and outputs the first data potential corresponding to a designation gradation of the first light emitting element to the data line, and in a second period after the first period, the driving circuit sets the first switching element to be turned off and the second switching element to be turned on, and outputs the second data potential corresponding to a designation gradation of the second light emitting element to the data line. In the aspect, in the first period, the first data potential output to the data line is supplied to the gate of the first driving transistor through the first switching element that is turned on. Accordingly, the driving current corresponding to the first data potential flows in the first light emitting element, and the first light emitting element emits light in a brightness corresponding to the driving current. In the second period, the second data potential output to the data line is supplied to the gate of the second driving transistor through the second switching element that is turned on. Accordingly, the driving current corresponding to the second data potential flows in the second light emitting element, and the second light emitting element emits light in a brightness corresponding to the driving current. That is, according to the aspect, it is possible to accurately perform display of one side and display of the other side of the substrate, and it is possible to provide a light emitting device capable of achieving high precision.

According to another aspect of the invention, there is provided a light emitting device including: a plurality of first scanning lines that extend in a first direction; a plurality of second scanning lines that are provided corresponding to the plurality of first scanning lines, respectively; a plurality of data lines that extend in a second direction different from the first direction; a plurality of pixel circuits provided corresponding to the intersections of the plurality of first scanning lines and the plurality of second scanning lines and the plurality of data lines; and a driving circuit that drives the pixel circuits, wherein each of the pixel circuits is provided on a substrate, and includes a first circuit and a second circuit provided corresponding to a first supply line, wherein the first circuit includes a first light emitting element, a first driving transistor connected between the first light emitting element and the first supply line, and a first switching element provided between a gate of the first driving transistor and the data line to electrically connect both when selecting the first scanning line, and outgoing light of the first light emitting element is output from one side of the substrate, wherein the second circuit includes a second light emitting element, a second driving transistor connected between the second light emitting element and the first supply line, and a second switching element provided between a gate of the second driving transistor and the data line to electrically connect both when selecting the second scanning line, and outgoing light of the second light emitting element is output from the other side of the substrate, and wherein the driving circuit sequentially selects the first scanning lines and selects the second scanning lines in a reverse direction to the selection direction of the first scanning lines for each selection period, and outputs data potential corresponding to image data to the data lines.

In the aspect, in the driving circuit, the selection direction of the first scanning line and the selection direction of the second scanning line are in the reverse direction to each other, and thus it is possible to arrange a state of viewing the image displayed on one side of the substrate from one side and a state of viewing the image displayed on the other side of the substrate from the other side. That is, according to the aspect, it is possible to prevent the image displayed on one side of the substrate and the image displayed on the other side from being inversed.

The light emitting device according to the aspect of the invention is used in various electronic apparatus. A typical example of the electronic apparatus is an apparatus using the light emitting device is a display device. An example of the electronic apparatus according to the aspect of the invention is a personal computer or a mobile phone.

According to another aspect of the invention, there is provided a method of driving a light emitting device including a pixel circuit that is provided on a substrate and a data line, the pixel circuit including a first circuit and a second circuit provided corresponding to a first supply line, the first circuit including a first light emitting element, a first driving transistor connected between the first light emitting element and the first supply line, and a first switching element provided between a gate of the first driving transistor and the data line, and the outgoing light of the first light emitting element is output from one side of the substrate, and the second circuit including a second light emitting element, a second driving transistor connected between the second light emitting element and the first supply line, and a second switching element provided between a gate of the second driving transistor and the data line, in which the outgoing light of the second light emitting element is output from the other side of the substrate, wherein in a first period, the first switching element is set to be turned on and the second switching element is set to be turned off, and the first data potential corresponding to a designation gradation of the first light emitting element is output to the data line, and wherein in a second period after the first period, the first switching element is set to be turned off and the second switching element is set to be turned on, and the second data potential corresponding to a designation gradation of the second light emitting element is output to the data line. According to the driving method described above, it is possible to obtain the same advantages as the light emitting device according to the aspect of the invention.

According to another aspect of the invention, there is provided a method of driving a light emitting device including a plurality of first scanning lines that extend in a first direction, a plurality of second scanning lines that are provided corresponding to the plurality of first scanning lines, respectively, a plurality of data lines that extend in a second direction different from the first direction, a plurality of pixel circuits provided corresponding to the intersections of the plurality of first scanning lines and the plurality of second scanning lines and the plurality of data lines, each of the pixel circuits being provided on a substrate, and including a first circuit and a second circuit provided corresponding to a first supply line, the first circuit including a first light emitting element, a first driving transistor connected between the first light emitting element and the first supply line, and a first switching element provided between a gate of the first driving transistor and the data line to electrically connect both when selecting the first scanning line, in which the outgoing light of the first light emitting element is output from one side of the substrate, the second circuit including a second light emitting element, and a second driving transistor connected between the second light emitting element and the first supply line, and a second switching element provided between a gate of the second driving transistor and the data line to electrically connect both when selecting the second scanning line, and the outgoing light of the second light emitting element is output from the other side of the substrate, wherein the first scanning lines are sequentially selected and the second scanning lines are sequentially selected in a reverse direction to the selection direction of the first scanning lines for each selection period, and the data potential corresponding to image data is output to the data lines. According to the driving method described above, it is possible to obtain the same advantages as the light emitting device according to the aspect of the invention.

### BRIEF DESCRIPTION OF THE DRAWINGS

The invention will be described with reference to the accompanying drawings, wherein like numbers reference like elements.

FIG. 1 is a block diagram illustrating a light emitting device according to a first embodiment of the invention.

FIG. 2 is a circuit diagram illustrating a pixel circuit.

FIG. 3 is a cross-sectional diagram illustrating the pixel circuit.

FIG. 4 is a diagram for describing signals generated by a driving circuit.

FIG. 5 is a diagram for describing an operation of the pixel circuit in a first selection period.

FIG. 6 is a diagram for describing an operation of the pixel circuit in a second selection period.

FIG. 7 is a timing chart for describing an operation of a light emitting device according to a second embodiment of the invention.

FIG. 8 is a timing chart for describing an operation of a comparative example.

FIG. 9 is a plan diagram of an image displayed on a front side of a panel viewed from the front side of the panel, for the comparative example.

FIG. 10 is a plan diagram of an image displayed on a back side of the panel viewed from the back side of the panel, for the comparative example.

FIG. 11 is a plan diagram of an image displayed on a front side of a panel from the front side of the panel, for the second embodiment.

FIG. 12 is a plan diagram of an image displayed on a back side of a panel from the back side of the panel, for the second embodiment.

FIG. 13 is a perspective diagram illustrating a specific form of an electronic apparatus according to the invention.

FIG. 14 is a perspective diagram illustrating a specific form of an electronic apparatus according to the invention.

FIG. 15 is a perspective diagram illustrating a specific form of an electronic apparatus according to the invention.

FIG. 16 is a diagram illustrating a pixel circuit in a light emitting device of the related art.

### DESCRIPTION OF EXEMPLARY EMBODIMENTS

### A: First Embodiment

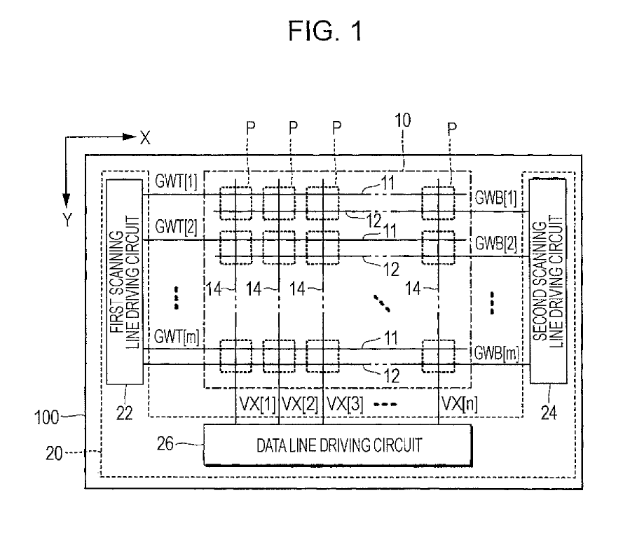

FIG. 1 is a block diagram illustrating a light emitting device 100 according to a first embodiment of the invention. The light emitting device 100 is mounted on an electronic apparatus as a display device displaying an image. As shown in FIG. 1, the light emitting device 100 includes an element unit 10 in which a plurality of pixel circuits P are arranged, and a driving circuit 20 driving the pixel circuits P. The driving circuit 20 includes a first scanning line driving circuit 22, a second scanning line driving circuit 24, and a data line driving circuit 26. The driving circuit 20 is mounted to be dispersed in, for example, a plurality of integrated circuits. At least a part of the driving circuit 20 may be configured by a thin-film transistor formed on a substrate with the pixel circuits P.

The element unit 10 is provided with m first scanning lines 11 extending in an X direction, m second scanning lines 12 corresponding to the first scanning lines 11 and extending in the X direction, and n data lines 14 extending in a Y direction intersecting with the X direction (m and n are natural numbers). The plurality of pixel circuits P are provided at intersections of the plurality of first scanning lines 11 and second scanning lines 12 and the plurality of data lines 14, and are arranged in matrix of m rows×n columns. The first scanning line driving circuit 22 outputs first scanning signals GWT [1] to GWT [m] to the first scanning lines 11. The second scanning line driving circuit 24 outputs second scanning signals GWB [1] to GWB [m] to the second scanning lines 12. The data line driving circuit 26 outputs data potentials VX [1] to VX [n] corresponding to gradations (hereinafter, referred to as “designation gradation”) designated for the pixel circuits P to the data lines 14. Specifications thereof will be described later.

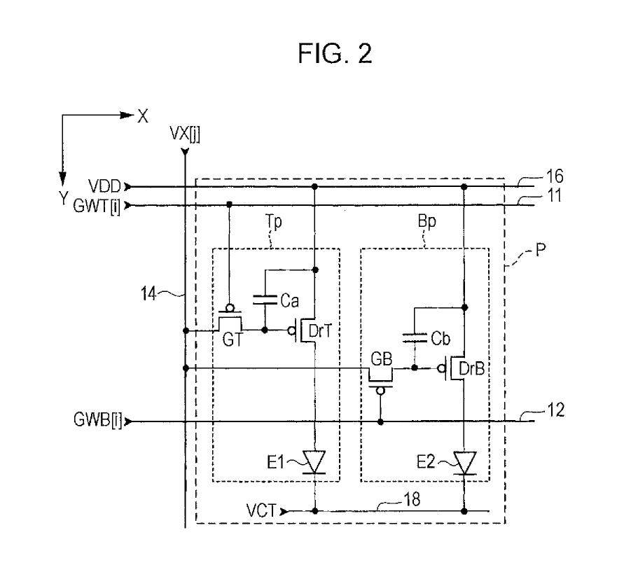

FIG. 2 is a circuit diagram illustrating the pixel circuit P. In FIG. 2, only one pixel circuit P positioned at the j-th (j=1 to n) column of the i-th row (1=1 to m) is representatively shown. As shown in FIG. 2, the pixel circuit P includes a first circuit Tp and a second circuit Bp provided corresponding to a high potential supply line 16 to which a high supply potential VDD is supplied and a low potential supply line 18 to which a low supply potential VCT (<VDD) is supplied. In the case of a small-size panel, a cathode is provided on one face throughout all the pixels, and thus there is a case where the low potential supply line 18 is not provided in a display area. In the case of a large-size panel, there is a case where the low potential supply line 18 is provided in the display area as an auxiliary cathode line.

As shown in FIG. 2, the first circuit Tp includes a first light emitting element E1 and a first driving transistor DrT, a storage capacitor Ca, and a first switching element GT. The first light emitting element E1 and the first driving transistor DrT are provided in series on a path connecting the high potential supply line 16 and the low potential supply line 18. The first light emitting element E1 is an OLED element in which a light emitting layer formed of an organic EL (Electroluminescense) material is interposed between an anode and a cathode opposed to each other.

The first driving transistor DrT is a P-channel transistor (for example, thin-film transistor) in which a source thereof is connected to the high potential supply line 16 and a drain is connected to the anode of the first light emitting element E1. The storage capacitor Ca is interposed between the gate and the source of the first driving transistor DrT.

The first switching element GT is interposed between the gate of the first driving transistor DrT and the data line 14 of the j-th column to control the electrical connection (connection/disconnection) of both. As shown in FIG. 2, for example, a P-channel transistor (for example, thin-film transistor) is appropriately employed as the first switching element GT. The gate of the first switching element GT of each of the n pixel circuits P belonging to the i-th row is commonly connected to the first scanning line 11 of the i-th row.

As shown in FIG. 2, the second circuit Bp includes a second light emitting element E2, a second driving transistor DrB, a storage capacitor Cb, and a second switching element GB. The second light emitting element E2 and the second driving transistor DrB are provided in series on a path connecting the high potential supply line 16 and the low potential supply line 18. The second light emitting element E2 is an OLED element.

The second driving transistor DrB is a P-channel transistor (for example, thin-film transistor) in which a source thereof is connected to the high potential supply line 16 and a drain is connected to the anode of the second light emitting element E2. The storage capacitor Cb is interposed between the gate and the source of the second driving transistor DrB.

The second switching element GB is interposed between the gate of the second driving transistor DrB and the data line 14 of the j-th column to control the electrical connection (connection/disconnection) of both. As shown in FIG. 2, for example, a P-channel transistor (for example, thin-film transistor) is appropriately employed as the second switching element GB. The gate of the second switching element GB of each of the n pixel circuits P belonging to the i-th row is commonly connected to the second scanning line 12 of the i-th row.

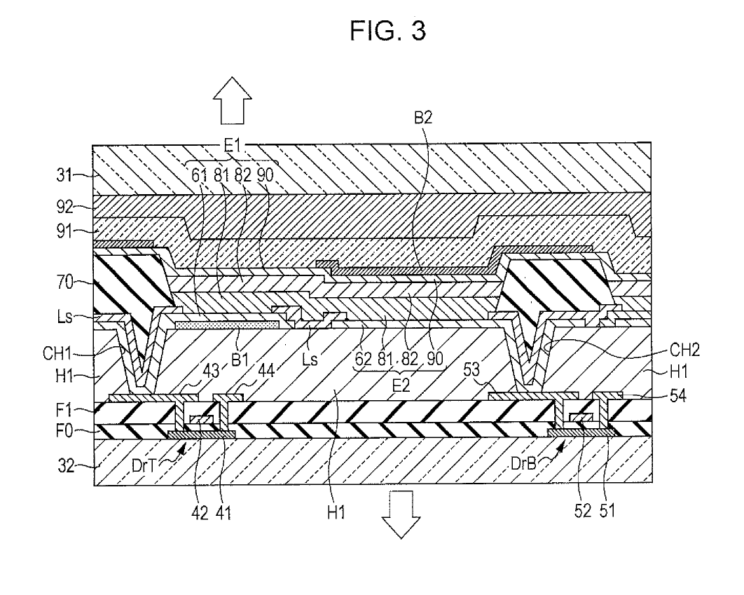

FIG. 3 is a cross-sectional diagram illustrating the pixel circuit P. In the embodiment, the pixel circuits P are provided between the first substrate 31 and the second substrate 32 opposed to each other. The first substrate 31 and the second substrate 32 are formed of a material with light permeability such as glass. In the embodiment, the outgoing light of the first light emitting element E1 of the pixel circuits P is output from the first substrate 31 side, and the outgoing light of the second light emitting element E2 of the pixel circuits P is output from the second substrate 32 side. Hereinafter, specifications thereof will be described below. When an element constituting the pixel circuit is provided on the second substrate 32 and the first substrate 31 is used as a protective substrate, a protective film including an organic or inorganic thin film may be used as a substituent means of the first substrate 31.

As shown in FIG. 3, various transistors included in the pixel circuit P are formed on the second substrate 32. In FIG. 3, the first driving transistor DrT and the second driving transistor DrB are representatively shown. The first driving transistor DrT includes a semiconductor layer 41 formed of a semiconductor material on the surface of the second substrate 32, and a gate electrode 42 opposed to the semiconductor layer 41 with a gate insulating layer F0 covering the semiconductor layer 41 interposed therebetween. The semiconductor layer 41 is a polysilicon film formed, for example, by laser annealing to amorphous silicon. The gate electrode 42 is covered with the first insulating layer F1. A drain electrode 43 and a source electrode 44 of the first driving transistor DrT are formed on a face of the first insulating layer F1 by a low-resistance metal such as aluminum, and are electrically connected to the semiconductor layer 41 (drain area and source area) through a contact hole.

The second driving transistor DrB includes a semiconductor layer 51 formed of a semiconductor material on the surface of the second substrate 32, and a gate electrode 52 opposed to the semiconductor layer 51 with the gate insulating layer F0 covering the semiconductor layer 51 interposed therebetween. In the same manner as the first driving transistor DrT, the gate electrode 52 is covered with the first insulating layer F1. A drain electrode 53 and a source electrode 54 of the second driving transistor DrB are formed on a face of the first insulating layer F1 by a low-resistance metal such as aluminum, and are electrically connected to the semiconductor layer 51 (drain area and source area) through a contact hole.

The drain electrode 43 and the source electrode 44 of the first driving transistor DrT, and the drain electrode 53 and the source electrode 54 of the second driving transistor DrB are covered with a planarization layer H1. A first pixel electrode 61 constituting the anode of the first light emitting element E1 and a second pixel electrode 62 constituting the anode of the second light emitting element E2 are separately formed on a face of the planarization layer H1. The first pixel electrode 61 and the drain electrode 43 of the first driving transistor DrT are connected through a contact hole CH1 formed in the planarization layer H1. The second pixel electrode 62 and the drain electrode 53 of the second driving transistor DrB are connected through the other contact hole CH2 formed in the planarization layer H1.

An organic bank 70 (separator) is formed on the first pixel electrode 61 and the second pixel electrode 62. The organic bank 70 separates the space on the surface of the second substrate 31 for each pixel circuit P, and is formed of an insulating transparent material, for example, acryl and polyimide. A laminated body (light emitting function layer) of a hole injection/transmission layer 81 and an organic EL layer 82 is formed on the first pixel electrode 61 and the second pixel electrode 62 separated by the organic bank 70. An opposed electrode 90 is formed to cover the light emitting function layer of the pixel circuit P and the organic bank 70. That is, the opposed electrode 90 is continuous throughout the plurality of pixel circuits P, and constitutes cathodes of the first light emitting element E1 and the second light emitting element E2 of the pixel circuits P.

As shown in FIG. 3, a lyophilic control layer Ls formed of a lyophilic material such as SiO₂ is formed between the organic bank 70 and the planarization layer H1, and between the first pixel electrode 61 and the second pixel electrode 62. As shown in FIG. 3, a transparent protective film 91 is formed on the opposed electrode 90. The transparent protective film 91 allows the outgoing light to pass, and is a member (gas barrier member) for preventing moisture or oxygen from infiltrating from the outside, and may be formed of silicon oxides (SiOx) or silicon nitride (SiNx). An adhesive layer 92 is formed on the transparent protective film 91. The adhesive layer 92 has a function of adhering the first substrate 31 onto the transparent protective film 91.

As shown in FIG. 3, a first light shielding film B1 is provided between the first pixel electrode 61 and the planarization layer H1, to prevent the outgoing light of the first light emitting element E1 from traveling to the second substrate 32. More specifically, the first light shielding film B1 is provided to cover an area (the light emitting area of the first light emitting element E1), which the outgoing light from the first light emitting element E1 can reach, on the face of the planarization layer H1. The first light shielding film B1 may be formed of a material having light reflectance such as aluminum or chromium. Accordingly, the light emitted from the first light emitting element E1 to the second substrate 32 is reflected by the first light shielding film B1 to be light toward the first substrate 31, and is output to the outside through the opposed electrode 90 or the first substrate 31 with the light emitted from the first light emitting element E1 to the first substrate 31. That is, the outgoing light of the first light emitting element E1 is output from the first substrate 31 side.

As shown in FIG. 3, a second light shielding film B2 is provided on the face of the opposed electrode 90 to prevent the outgoing light of the second light emitting element E2 from traveling to the first substrate 31. More specifically, the second light shielding film B2 is provided to cover an area (the light emitting area of the second light emitting element E2), which the outgoing light of the second light emitting element E2 can reach, on the face of the opposed electrode 90. The second light shielding film B2 may be formed of a material having light reflectance such as aluminum or chromium. Accordingly, the light emitted from the second light emitting element E2 to the first substrate 31 is reflected by the second light shielding film B2 to be light toward the second substrate 32, and is output to the outside through the second pixel electrode 62 or the second substrate 32 with the light emitted from the second light emitting element E2 to the second substrate 32. That is, the outgoing light of the second light emitting element E2 is output from the second substrate 32 side.

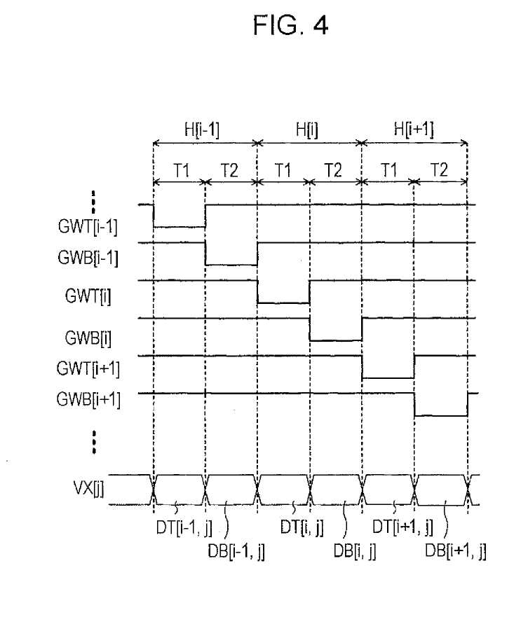

Next, signals generated by the first scanning line driving circuit 22, signals generated by the second scanning line driving circuit 24, and signals generated by the data line driving circuit 26 will be described with reference to FIG. 4. As shown in FIG. 4, each of m horizontal scanning periods (H [1] to H [m]) in a vertical scanning period is divided into a first selection period T1 and a second selection period T2 after the first selection period T1.

The first scanning line driving circuit 22 sequentially sets the first scanning signals GWT [1] to GWT [m] to an active level (low level) in each first selection period T1, thereby sequentially selecting the first scanning lines 11. The transition of the first scanning signal GWT [i] to the low level means selection of the first scanning line 11 of the i-th row. When the first scanning signal GWT [i] is transited to the low level, the first switching elements GT of the n pixel circuits P belonging to the i-th row are simultaneously turned on.

The second scanning line driving circuit 24 sequentially sets the second scanning signals GWB [1] to GWB [m] to the active level (low level) in each second selection period T2, thereby sequentially selecting the second scanning lines 12. The transition of the second scanning signal GWB [i] to the low level means selection of the second scanning line 12 of the i-th row. When the second scanning signal GWB [1] is transited to the low level, the second switching elements GB of the n pixel circuits P belonging to the i-th row are simultaneously turned on.

The data line driving circuit 26 generates data potentials VX [1] to VX [n] corresponding to the pixel circuits P (n circuits) of one line selected by the first scanning line driving circuit 22 and the second scanning line driving circuit 24 in each horizontal scanning period H, and outputs them to the data lines 14. As shown in FIG. 4, a value of the data potential VX [j] output to the data line 14 of the j-th column in the first selection period T1 in the horizontal scanning period H [i] when the i-th row is selected, is set to a value DT [i, j] corresponding to a designation gradation of the first light emitting element E1 of the pixel circuit P positioned at the j-th column of the i-th row. A value of the data potential VX [j] output to the data line 14 of the j-th column in the second selection period T2 in the horizontal scanning period H [i] is set to a value DB [i, j] corresponding to a designation gradation of the second light emitting element E2 of the pixel circuit P positioned at the j-th column of the i-th row.

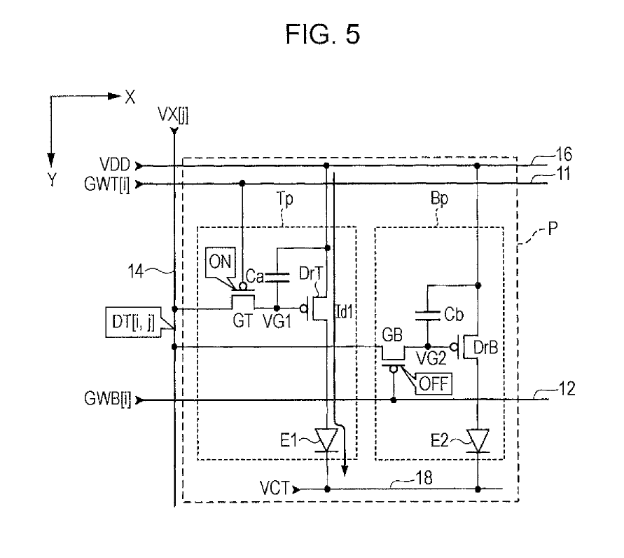

Next, paying attention to the pixel circuit P of the j-th column of the i-th row, a specific operation (driving method) of the light emitting device 100 will be described. As shown in FIG. 4, when the first selection period T1 of the i-th horizontal scanning period H [1] in the vertical scanning period is started, the first scanning line driving circuit 22 sets the first scanning signal GWT [i] output to the first scanning line 11 of the i-th row to the low level (active level). Meanwhile, the second scanning line driving circuit 24 sets the second scanning signal GWB [i] output to the second scanning line 12 of the i-th row to the high level (inactive level). As shown in FIG. 5, the first switching element GT is turned on, and the second switching element GB is turned off. As shown in FIG. 4 and FIG. 5, the data line driving circuit 26 sets the value of the data potential VX [j] output to the data line 14 of the j-th column to the potential DT [i, j] corresponding to the designation gradation of the first light emitting element E1.

At this time, the gate of the first driving transistor DrT is electrically connected to the data line 14 of the j-th column through the first switching element GT that is turned on, and thus the potential VG1 of the gate of the first driving transistor DrT is set to the potential DT [i, j]. Accordingly, the driving current Id1 corresponding to the potential DT [i, j] is generated by the first driving transistor DrT, and the generated driving current Id1 flows in the first light emitting element E1. The first light emitting element E1 emits light in a brightness corresponding to the driving current Id1.

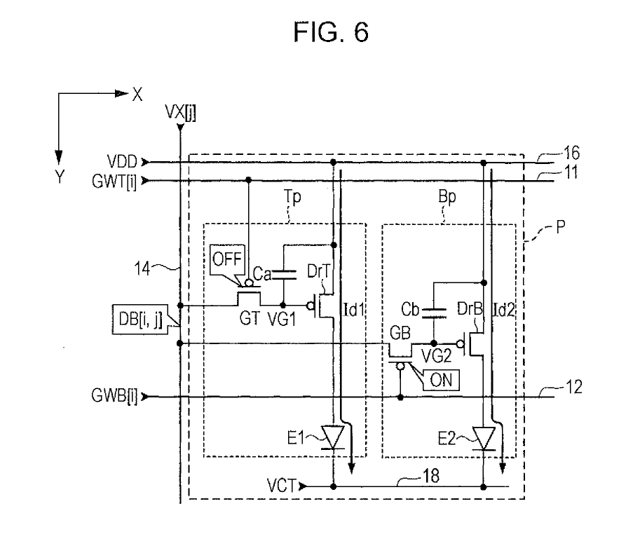

Thereafter, when the first selection period T1 is ended and the second selection period T2 is started, as shown in FIG. 4, the first scanning line driving circuit 22 sets the first scanning signal GWT [i] to the inactive level (high level). Meanwhile, the second scanning line driving circuit 24 sets the second scanning signal GWB [i] to the active level (low level). Accordingly, as shown in FIG. 6, the first switching element GT is turned off, and the second switching element GB is turned on. In this case, when the first switching element GT is turned off, the potential VG1 of the gate of the first driving transistor DrT is kept in the potential DT [i, j] at the end point of the first selection period T1 by the storage capacitor Ca. Accordingly, the driving current Id1 continues to flow in the first light emitting element E1. That is, the first light emitting element E1 continues to emit light in the brightness corresponding to the driving current Id1 during the period until the first period T1 of the i-th horizontal scanning period H [i] in the next vertical scanning period is started.

As shown in FIG. 4 and FIG. 5, in the second selection period T2 of the horizontal scanning period H [i], the data line driving circuit 26 sets the value of the data potential VX [j] output to the data line 14 of the j-th column to the potential DB [i, j] corresponding to the designation gradation of the second light emitting element E2. In this case, the gate of the second driving transistor DrB is electrically connected to the data line 14 of the j-th column through the second switching element GB that is turned on, and thus the potential VG2 of the gate of the second driving transistor DrB is set to the potential DB [i, j]. Accordingly, the driving current 1d2 corresponding to the potential DB [1, j] is generated by the second driving transistor DrB, and the generated driving current Id2 flows in the second light emitting element E2. The second light emitting element E2 emits light in a brightness corresponding to the driving circuit 1d2.

As shown in FIG. 4, when the second selection period T2 of the horizontal scanning period H [1] is ended, the second scanning line driving circuit 24 sets the second scanning signal GWB [i] to the inactive level (high level), Accordingly, the second switching element GB is turned off. Even when the second switching element GB is turned off, the potential VG2 of the gate of the second driving transistor DrB is kept in the potential DB [i, j] at the end point of the second selection period T2 by the storage capacitor Cb. Accordingly, the driving current 1d2 continues to flow in the second light emitting element E2. That is, the second light emitting element E2 continues to emit light in the brightness corresponding to the driving current 1d2 during the period before the second period T2 of the i-th horizontal scanning period H [i] in the next vertical scanning period is started.

As described above, in the pixel circuits P of the embodiment, the first circuit Tp for generating the image displayed on the first substrate 31 side, and the second circuit Bp for generating the image displayed on the second substrate 32 side share one data line 14. Accordingly, it is possible to reduce the area per pixel, as compared with the aspect (that is to say, two data lines are provided for each pixel) in which the data line corresponding to the first circuit Tp and the data line corresponding to the second circuit Bp are separately provided. Therefore, according to the embodiment, there is an advantage of achieving high precision of the image as compared with the aspect in which two data lines are provided for each pixel.

### B: Second Embodiment

A second embodiment is different from the first embodiment in that images to be displayed on the first substrate 31 side (hereinafter, referred to as “the front side of the panel”) and the second substrate 32 side (hereinafter, referred to as “the back side of the panel”) are the same, the driving circuit 20 sequentially selects the first scanning lines 11 in each horizontal scanning period H and sequentially selects the second scanning lines 12 in a reverse direction to the selection direction of the first scanning lines 11, and the data potential corresponding to the image data is output to the data lines 14. Hereinafter, specification thereof will be described.

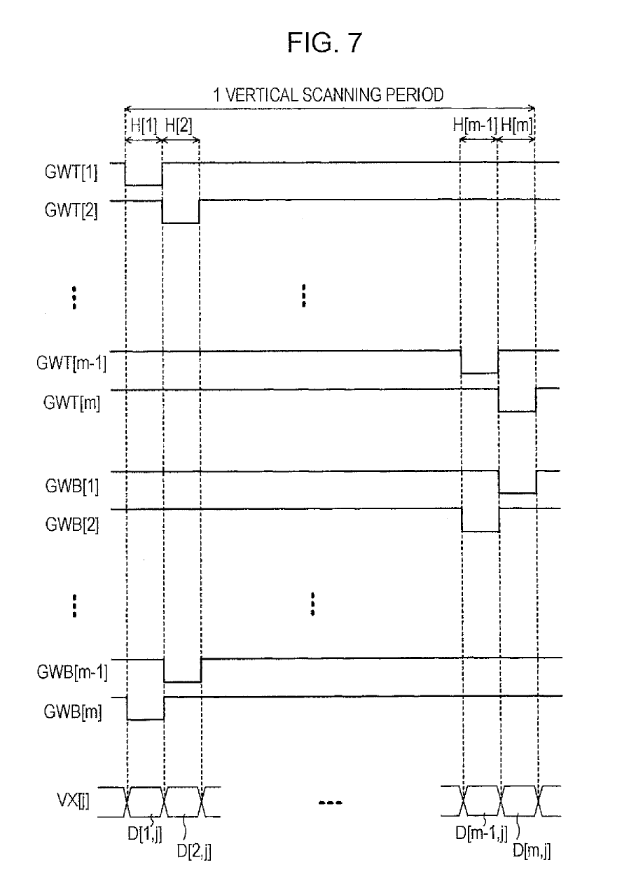

FIG. 7 is a timing chart for describing a specific operation of a light emitting device according to the second embodiment. As shown in FIG. 7, the first scanning line driving circuit 22 sequentially sets the first scanning signals GWT [1] to GWT [m] to the active level (low level) for each of the m horizontal scanning periods (H [1] to H [m]) in the vertical scanning period, thereby sequentially selecting the first scanning lines 11. More specifically, the first scanning line driving circuit 22 selects the first scanning lines 11 in order of the first row→the second row→ . . . →the m-th row. That is, in the first horizontal scanning period H [1], the first scanning signal GWT [1] output to the first scanning line 11 of the first row is set to the low level, and in the second horizontal scanning period H [2], the first scanning signal GWT [2] output to the first scanning line 11 of the second row is set to the low level. Thus, in the m-th horizontal scanning period H [m], the first scanning signal GWT [m] output to the first scanning line 11 of the m-th row is set to the low level.

As shown in FIG. 7, the second scanning line driving circuit 24 sequentially selects the second scanning lines 12 in a reverse direction to the selection direction of the first scanning lines 11 for each of the m horizontal scanning periods (H [1] to H [m]) in the vertical scanning period. More specifically, the second scanning line driving circuit 24 selects the second scanning lines 12 in order of the m-th row→the (m−1)-th row→ . . . →the first row. That is, in the first horizontal scanning period H [1], the second scanning signal GWB [m] output to the second scanning line 12 of the m-th row is set to the low level, and in the second horizontal scanning period H [2], the second scanning signal GWB [m−1] output to the second scanning line 12 of the (m−1)-th row is set to the low level. Thus, in the m-th horizontal scanning period H [m], the second scanning signal GWB [1] output to the second scanning line 12 of the first row is set to the low level.

The data line driving circuit 26 generates the data potential VX corresponding to the image data in each horizontal scanning period H, and outputs it to each data line 14. A value of the data potential VX [j] output to the data line 14 of the j-th column in the i-th horizontal scanning period H [i] is represented by D [i, j]. As shown in FIG. 7, for example, the value of the data potential VX [j] output to the data line 14 of the j-th column in the first horizontal scanning period H [1] in the vertical scanning period is D [1, j], and the value of the data potential VX [j] output to the data line 14 of the j-th column in the second horizontal scanning period H [2] is D [2, j].

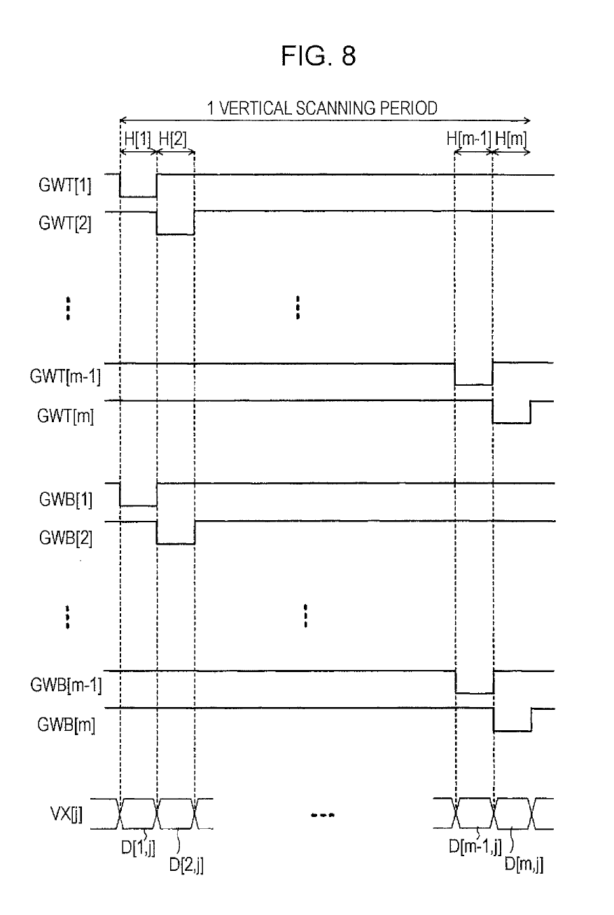

Now, an aspect (referred to as “comparative example”) of sequentially selecting the first scanning lines 11, sequentially selecting the second scanning lines 12 in the same direction as the selection direction of the first scanning lines 11, and outputting the data potential corresponding to image data to the data lines 14, in each horizontal scanning period H is assumed. FIG. 8 is a timing chart illustrating a specific operation of the comparative example. In the comparative example, in the i-th horizontal scanning period H [i] in the vertical scanning period, the first scanning line 11 of the i-th row and the second scanning line 12 of the i-th row are simultaneously selected. As shown in FIG. 8, for example, in the first horizontal scanning period H [1], the first scanning signal GWT [1] output to the first scanning line 11 of the first row and the second scanning signal GWB [1] output to the second scanning line 12 of the first row are simultaneously set to the low level. In the second horizontal scanning period H [2], the first scanning signal GWT [2] output to the first scanning line 11 of the second row and the second scanning signal GWB [2] output to the second scanning line 12 of the second row are simultaneously set to the low level.

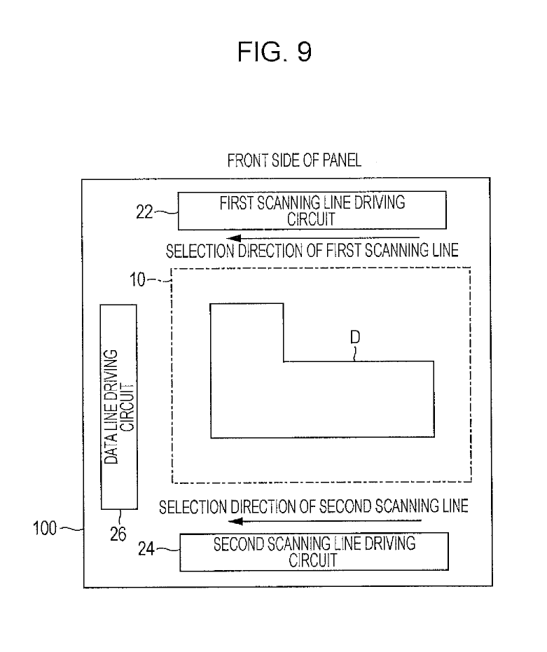

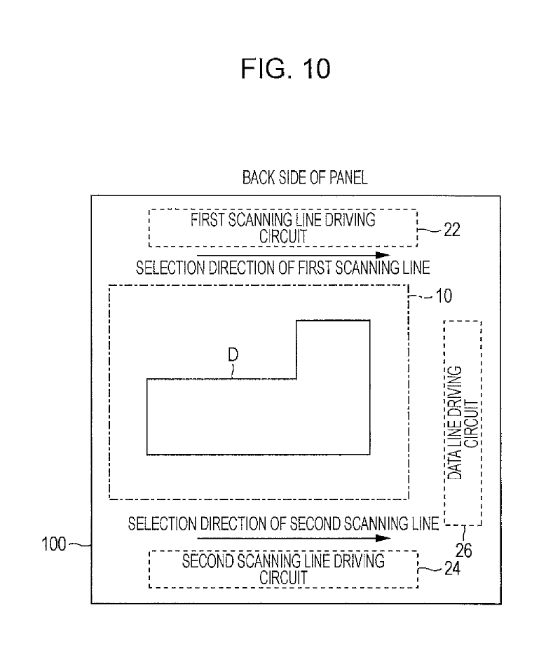

FIG. 9 is a plan diagram of an image D displayed on the front side of the panel viewed from the front side of the panel in the comparative example. FIG. 10 is a plan diagram of the image D displayed on the back side of the panel viewed from the back side of the panel in the comparative example. As described above, in the comparative example, since the selection direction of the first scanning lines 11 and the selection direction of the second scanning lines 12 are the same direction, as shown in FIG. 9 and FIG. 10, the image D displayed on the front side of the panel and the image D displayed on the back side of the panel are reversed left and right (a mirror character in a case where the image D is a character), which is not preferable.

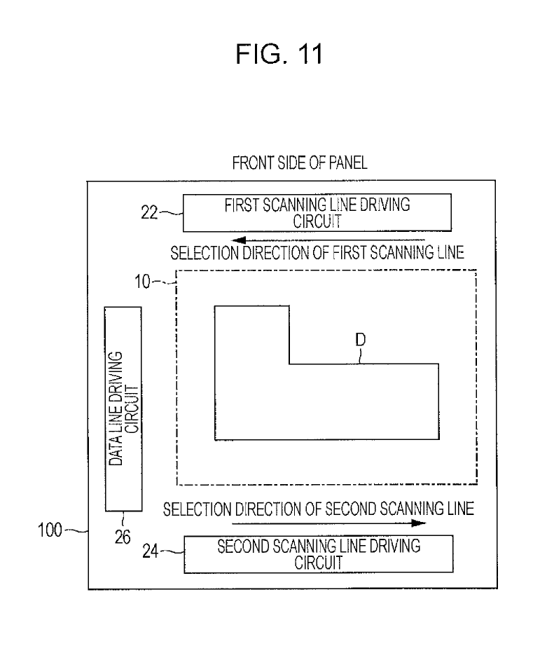

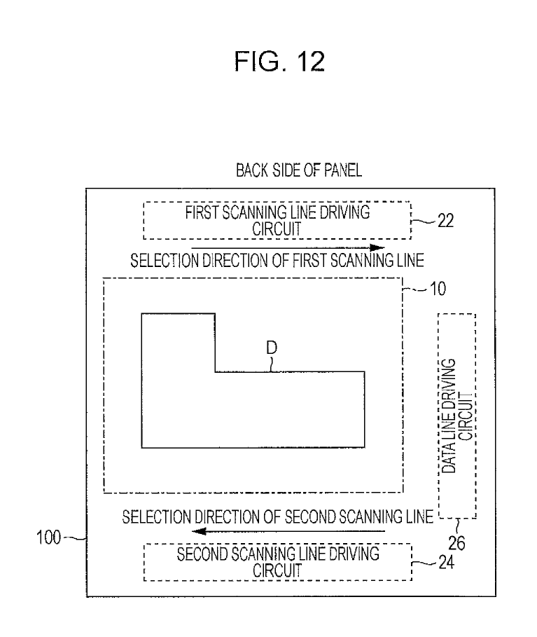

On the contrary, in the embodiment, as described above, for each horizontal scanning period H, the first scanning lines 11 are sequentially selected, the second scanning lines 12 are sequentially selected in a reverse direction to the selection direction of the first scanning lines 11, and the data potential VX corresponding to the image data is output to the data lines 14. Accordingly, the state of viewing the image D displayed on the front side of the panel from the front side of the panel and the state of viewing the image D displayed on the back side of the panel from the back side of the panel can be arranged. FIG. 11 is a plan diagram of the image D displayed on the front side of the panel viewed from the front side of the panel in the embodiment. FIG. 12 is a plan diagram of the image D displayed on the back side of the panel viewed from the back side of the panel in the embodiment. As can be understood from FIG. 11 and FIG. 12, according to the embodiment, it is possible to prevent the image displayed on the front side of the panel and the image D displayed on the back side of the panel from being reversed between left and right. In the embodiment, since the same image is displayed on the front side and the back side of the panel, the data line driving circuit 26 does not have to separately output the data of the image displayed on the front side of the panel and the data of the image displayed on the back side of the panel. Accordingly, there is also an advantage of reducing power consumption of the data line driving circuit 26.

### C: Modified Example

The invention is not limited to the above-described embodiments, and may be modified as follows. Two or more modified examples of the following modified examples may be combined.

### (1) Modified Example 1

The conductive types of various transistors included in the pixel circuits P are arbitrary. In the embodiments, all the various transistors included in the pixel circuits P are formed of the p-channel transistors, but are not limited thereto, for example, all the various transistors included in the pixel circuits P may be the N-channel type. For example, a part of the transistors among various transistors included in the pixel circuits P may be formed of the P-channel type, and the other transistors may be formed of the N-channel type.

### (2) Modified Example 2

In the first embodiment, the driving circuit 20 (data line driving circuit 26) may selectively allow either of the front side (first substrate 31 side) of the panel or the back side (second substrate 32 side) of the panel to emit light. For example, in each first selection period T1, the data line driving circuit 26 may generate the data potential VX corresponding to the lowest gradation (for example, “black”) to output to the data lines 14, thereby making the front side (first substrate 31 side) of the panel into a non-display state (state of displaying only black). Similarly, in each second selection period T2, the data line driving circuit 26 may generate the data potential VX corresponding to the lowest gradation to output it to the data lines 14, thereby making the back side (second substrate 32 side) of the panel into the non-display state.

### (3) Modified Example 3

In the second embodiment, the selection direction of the first scanning lines 11 is the direction from the first scanning line 11 of the first row to the first scanning line 11 of the m-th row, and the selection direction of the second scanning lines 12 is the direction from the second scanning line 12 of the m-th row to the second scanning line 12 of the first row, but they are not limited thereto. For example, the selection direction of the first scanning lines 11 may be the direction from the first scanning line 11 of the m-th row to the first scanning line 11 of the first row, and the selection direction of the second scanning lines 12 may be the direction from the second scanning line 12 of the first row to the second scanning line 12 of the m-th row. In brief, for each horizontal scanning period H, the first scanning lines 11 may be sequentially selected, and the second scanning lines 12 may be sequentially selected in the reverse direction to the selection direction of the first scanning lines 11.

### (4) Modified Example 4

The light emitting elements E (E1 and E2) may be OLED elements, or may be inorganic light emitting diodes or LEDs (Light Emitting Diode). The important point is to use general elements emitted according to the supply of electric energy (applying of electric field or supplying of current), as the light emitting elements of the invention.

### D: Application Example

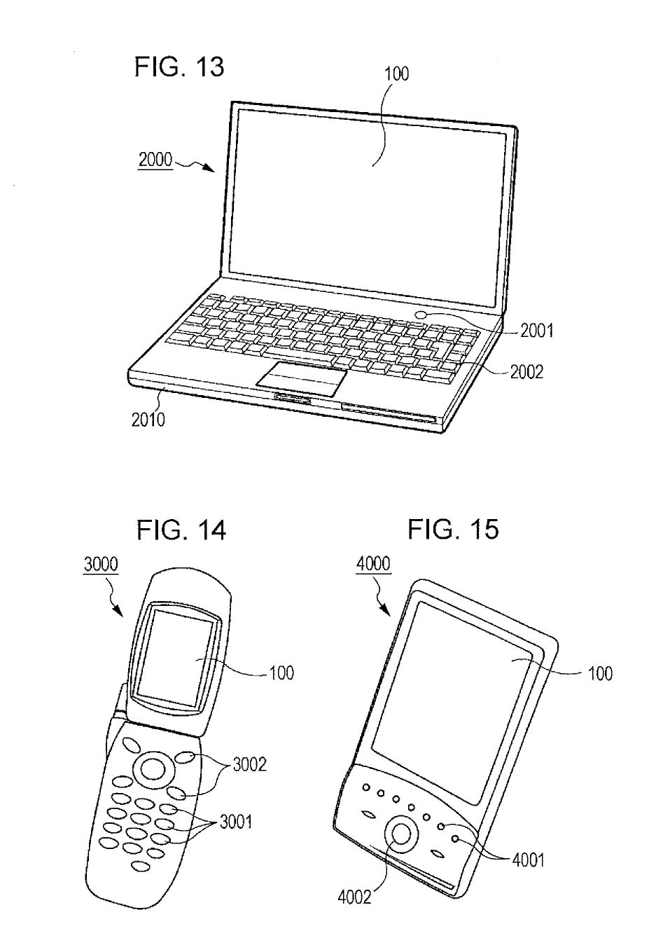

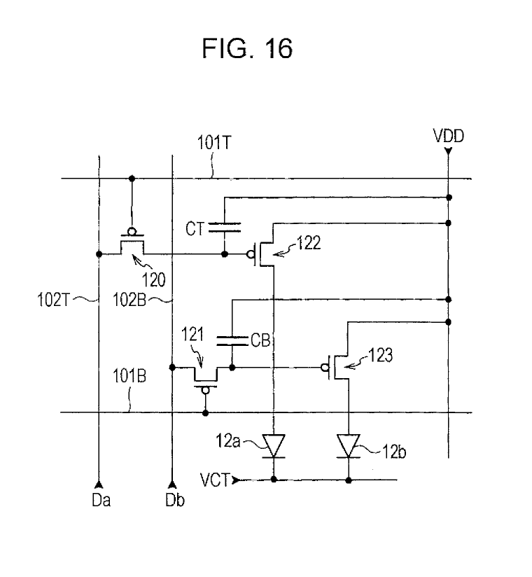

Next, an electronic apparatus using the light emitting device according to the invention will be described. FIG. 13 is a perspective diagram illustrating a configuration of a mobile personal computer employing the light emitting device 100 according to the embodiments described above as a display device. A personal computer 2000 is provided with the light emitting device 100 as the display device, and a main body unit 2010. The main body unit 2010 is provided with a power supply switch 2001, and a keyboard 2002. Since the light emitting device 100 uses the OLED elements as the light emitting elements E, it is possible to display an easily-visible image with a wide viewing angle.

FIG. 14 shows a configuration of a mobile phone employing the light emitting device 100 according to the embodiments described above as a display device. The mobile phone 3000 is provided with a plurality of operation buttons 3001, a scroll button 3002, and the light emitting device 100. The image displayed on the light emitting device 100 is scrolled by operating the scroll button 3002.

FIG. 15 shows a configuration of a mobile information terminal (PDA: Personal Digital Assistants) employing the light emitting device 100 according to the embodiments described above as a display device. The mobile information terminal 4000 is provided with a plurality of operation buttons 4001, a power supply switch 4002, and the light emitting device 100. When the power supply switch 4002 is operated, various kinds of information such as an address book and a schedule notepad are displayed on the light emitting device 100.

In addition to the apparatuses shown in FIG. 13 to FIG. 15, the electronic apparatus to which the light emitting device according to the invention is applied may be a digital camera, a television, a video camera, a car navigation apparatus, a pager, an electronic notebook, an electronic paper, a calculator, a word processor, a work station, a video phone, a POS terminal, a printer, a scanner, a copier, a video player, an apparatus provided with a touch panel, and the like.

This application claims priority from Japanese Patent Application No. 2010-054098 filed in the Japanese Patent Office on Mar. 11, 2010, the entire disclosure of which is hereby incorporated by reference in its entirely.

What is claimed is:

1. A light emitting device comprising:
a plurality of first scanning lines that extend in a first direction;
a plurality of second scanning lines that are provided corresponding to the plurality of first scanning lines, respectively;
a plurality of data lines that extend in a second direction different from the first direction;
a plurality of pixel circuits provided corresponding to intersections of the plurality of first scanning lines and the plurality of second scanning lines and the plurality of data lines; and
a driving circuit that drives the pixel circuits,
wherein each of the pixel circuits is provided on a substrate, and includes a first circuit and a second circuit provided corresponding to a first supply line,
wherein the first circuit includes a first light emitting element, a first driving transistor connected between the first light emitting element and the first supply line, and a first switching element provided between a gate of the first driving transistor and the data line to electrically connect both when selecting the first scanning line, and outgoing light of the first light emitting element is output from a direction opposite to the substrate,
wherein the second circuit includes a second light emitting element, a second driving transistor connected between the second light emitting element and the first supply line, and a second switching element provided between a gate of the second driving transistor and the data line to electrically connect both when selecting the second scanning line, and outgoing light of the second light emitting element is output through the substrate, and
wherein the driving circuit sequentially selects the first scanning lines and selects the second scanning lines in a reverse direction to the selection direction of the first scanning lines for each selection period, and outputs data potential corresponding to image data to the data lines.

2. An electronic apparatus comprising the light emitting device according to claim 1.

3. A method of driving a light emitting device including a plurality of first scanning lines that extend in a first direction, a plurality of second scanning lines that are provided corresponding to the plurality of first scanning lines, respectively, a plurality of data lines that extend in a second direction different from the first direction, a plurality of pixel circuits provided corresponding to intersections of the plurality of first scanning lines and the plurality of second scanning lines and the plurality of data lines, each of the pixel circuits being provided on a substrate, and including a first circuit and a second circuit provided corresponding to a first supply line, the first circuit including a first light emitting element, a first driving transistor connected between the first light emitting element and the first supply line, and a first switching element provided between a gate of the first driving transistor and the data line to electrically connect both when selecting the first scanning line, in which outgoing light of the first light emitting element is output from a direction opposite to the substrate, the second circuit including a second light emitting element, and a second driving transistor connected between the second light emitting element and the first supply line, and a second switching element provided between a gate of the second driving transistor and the data line to electrically connect both when selecting the second scanning line, and outgoing light of the second light emitting element is output through the substrate,
wherein the first scanning lines are sequentially selected and the second scanning lines are sequentially selected in a reverse direction to the selection direction of the first scanning lines for each selection period, and data potential corresponding to image data is output to the data lines.
